(19) United States
(12) Patent Application Publication
(10) Pub. No.: US 2018/0043837 A1
(43) Pub. Date: Feb. 15, 2018

(54) ACCESSORY MOUNTING SYSTEM FOR PERSONAL MOBILITY VEHICLE

(71) Applicant: Tyrone Soklaski, West Palm Beach, FL (US)

(72) Inventor: Tyrone Soklaski, West Palm Beach, FL (US)

(21) Appl. No.: 15/790,060

(22) Filed: Oct. 23, 2017

Related U.S. Application Data
(63) Continuation-in-part of application No. 15/184,920, filed on Jun. 16, 2016.

(51) Int. Cl. B60R 9/06; A61G 5/10

(52) U.S. Cl. CPC B60R 9/065; A61G 5/10; B60R 7/02

(57) ABSTRACT

A frame having one or more linear guide systems includes a mounting mechanism for attaching the frame to a personal mobility device. One or more carriages are slidingly engaged to a linear guide system. The carriages include components such as a cup holder, an umbrella holder, a basket, a cane holder or other storage device.

### CROSS-REFERENCE TO RELATED APPLICATIONS

This application is a Continuation-in-Part of Utility Patent application Ser. No. 15/184,920 filed on Jun. 16, 2016, which is a continuation-in-part of U.S. patent application Ser. No. 14/477,854 filed on Sep. 4, 2014 and claims priority to U.S. Provisional Application Ser. No. 61/873,831 filed Sep. 4, 2013.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to devices and methods for storing personal articles on a personal mobility device. More particularly, the invention relates to a frame having carriages slidingly engaged to a linear guide system on a frame mounted on a personal mobility device.

### Description of the Related Art

Personal mobility vehicles, such as for example motorized scooters and powered wheelchairs, have become increasingly common. They allow persons having limited mobility such as the disabled, amputees and the elderly to enjoy increased independence and improved quality of life. They come in a variety of designs including both compact, collapsible and full-sized wheelchairs and more versatile scooters, for example Rascal® brand mobility vehicles. They are commonly transported on a lift platform attached to the rear of an automobile or folded inside a vehicle. Operators of personal mobility vehicles use them for extended periods while shopping in large stores and shopping malls, going to church, attending events and any other occasion in which substantial distances are traveled outside of an automobile.

A variety of accessories such as baskets and other attachments for personal mobility vehicles have become increasingly common. Accessories have been designed for storing canes, umbrellas, purses, groceries, briefcases, laptops, luggage and medical equipment such as oxygen tanks. Attachments of also been designed for displaying flags and other ornamentation. Many of these accessories are modified versions of existing designs used with bicycles, motorcycles and other smaller transportation devices. However, these devices are generally not designed to be used with a combination of other devices and are incompatible with simultaneous attachment and use with a personal mobility vehicle. The operator of a personal mobility device often has difficulty attaching a storage basket and a cane holder to a mobility device to which an oxygen tank has already been attached.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide attachment systems for personal mobility devices capable of accommodating multiple attachments for holding, retaining and/or securing a variety of different objects.

It is also desirable to provide attachment systems for personal mobility devices that allow an operator to arrange objects held by attachments in a particular preferred orientation relative to one another and the chair of the personal mobility device.

### BRIEF SUMMARY OF THE INVENTION

Disclosed is a storage system for storing one or more personal articles on a personal mobility device comprising an elongate frame having a linear guide system extending along a length of the frame. A mechanism affixes the storage system frame to a personal mobility device for attaching. A carriage is slidingly engaged to the linear guide system of the elongate frame. The carriage includes at least one storage device selected from the group consisting of a basket, a cup holder, a clamp, a bracket configured to hold a pressurized tank, an umbrella holder, a cane holder, and an articulating arm.

In one embodiment, a system for storing one or more personal articles on a personal mobility device is removably attached to the carriage. The storage device is removably attached to the carriage by a mechanism selected from the group consisting of a gravity lock, a chase mortise gravity lock, a female receiving port, a mounting post, a threaded mounting post, a bore and a threaded bore.

In another embodiment, the storage system includes a carriage having a brake configured to secure the carriage at a location along the integral guide system. A mounting post extends from the elongate frame and is removably secured to the personal mobility device.

It is therefore an object of the present invention to provide a storage system for storing and transporting personal items on a personal mobility device.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a canopy frame attached to a scooter lift in accordance with the principles of the invention;

FIG. 2 is a side view of a scooter lift canopy in accordance with the principles of the invention;

FIG. 3 is an environmental view of an alternative embodiment of a scooter lift canopy in accordance with the principles of the invention;

FIG. 4 is an environmental view of an alternative embodiment of a scooter lift canopy in accordance with the principles of the invention;

FIG. 5 is a perspective side view of a system for retaining one or more personal articles on a personal mobility device in accordance with the principles of the invention;

FIG. 6 is another perspective view of a system for retaining one or more personal articles on a personal mobility device in accordance with the principles of the invention;

FIG. 7 is another side perspective view of a system for retaining one or more personal articles on a personal mobility device in accordance with the principles of the invention;

FIG. 8 is another side perspective view of a system for retaining one or more personal articles on a personal mobility device in accordance with the principles of the invention;

FIG. 9 is another side perspective view of a system for retaining one or more personal articles on a personal mobility device in accordance with the principles of the invention;

FIG. 10 is another side perspective view of a system for retaining one or more personal articles on a personal mobility device in accordance with the principles of the invention;

FIG. 11 is a perspective view of a storage device comprising a cup holder removably connectable to an attachment for a system for retaining one or more articles on a personal mobility device in accordance with the principles of the invention;

FIG. 12 is side elevation view of a storage device comprising an umbrella holder removably connectable to an attachment for a system for retaining one or more articles on a personal mobility device in accordance with the principles of the invention;

FIG. 13 is another side elevation view of a storage device comprising a umbrella holder removably connectable to an attachment for a system for retaining one or more articles on a personal mobility device in accordance with the principles of the invention;

FIG. 14 is a side perspective view of a storage device comprising an articulating arm removably connectable to an attachment for a system for retaining one or more articles on a personal mobility device in accordance with the principles of the invention;

FIG. 15 is a side perspective view of an alternative embodiment of a storage device comprising an articulating arm removably connectable to an attachment for a system for retaining one or more articles on a personal mobility device in accordance with the principles of the invention;

FIG. 16 is a side perspective view of an alternative embodiment of a storage device comprising a basket in accordance with principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

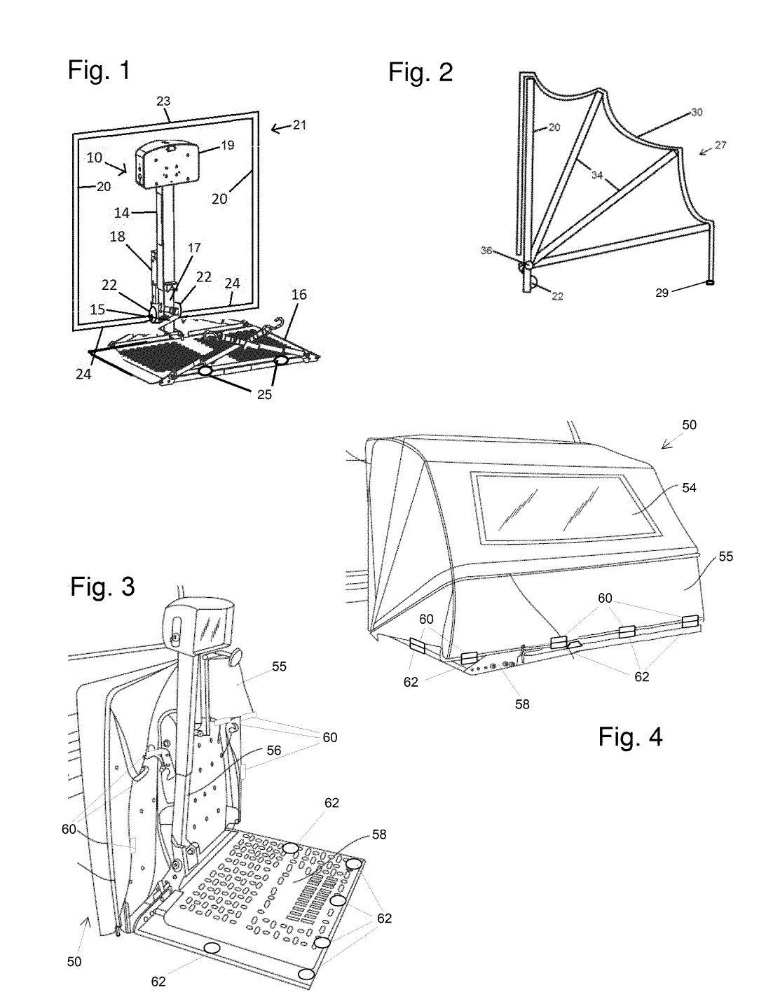

FIG. 1 shows a frame 21 attached to a scooter lift 10 in accordance with the principles of the invention. The frame 21 in this embodiment is substantially rectangular having to horizontal beams 23 and 24, and two opposing vertical struts 20. The frame 21 is affixed to a scooter lift 10 having a base 15, an elevator 17, a main body 14, a control box 19 and a platform 16. Mounting points 22 of the frame 21 may be attached to the base 15, to the body 14 or to the elevator 17. Optionally, it may be desirable to attach the frame to the bracket 18. This may allow the frame 22 to be secured to the lift 10 without getting in the way of or interfering with the other components of the lift 10. In this embodiment, the platform includes two small magnetic plates 25 on the platform 16 which are complementary to magnets on a flexible cover extending over the scooter lift 10 and the frame 21.

FIG. 2 shows an extendable canopy 27 attached to the frame 21. For clarity, the scooter lift 10 is not shown. The extendable canopy 27 has three folding arms 34 attached at two pivot points 36 located on each of the vertical struts 20. The folding arms 34 pivot about the pivot point 36 such that they fold out and over a scooter located on the platform 16. A sheet 30 is attached to the folding arms 34 of the extendable canopy 27. The folding arms 34 extend from the frame 21 in an accordion style. The sheet 30 also includes magnets 29 complementary to the magnetic plates 25 on the platform 16. When the folding arms 34 and sheet 30 are extended over a scooter lift and scooter, the magnets 29 align with magnetic plates 25 and connect. The use of magnets obviates the need for bungee cords, zippers, laces and other bulky connection mechanisms.

FIGS. 3 and 4 show an alternative embodiment of a scooter lift canopy 50 in accordance with the principles of the invention. FIG. 3 shows the canopy 50 in the stored position. FIG. 4 shows the canopy 50 extended deployed position. The canopy 50 includes a canopy sheet 52 having a window 54 and a lower skirt 55. The canopy 50 is attached to a scooter lift 56 having a platform 58. The canopy sheet skirt 55 includes several magnets 60 complementary to magnetic plates 62 on the platform 58. When the canopy is deployed, the magnets 60 on the canopy sheet 52 connect to the complementary magnetic plates 62 on the platform 58.

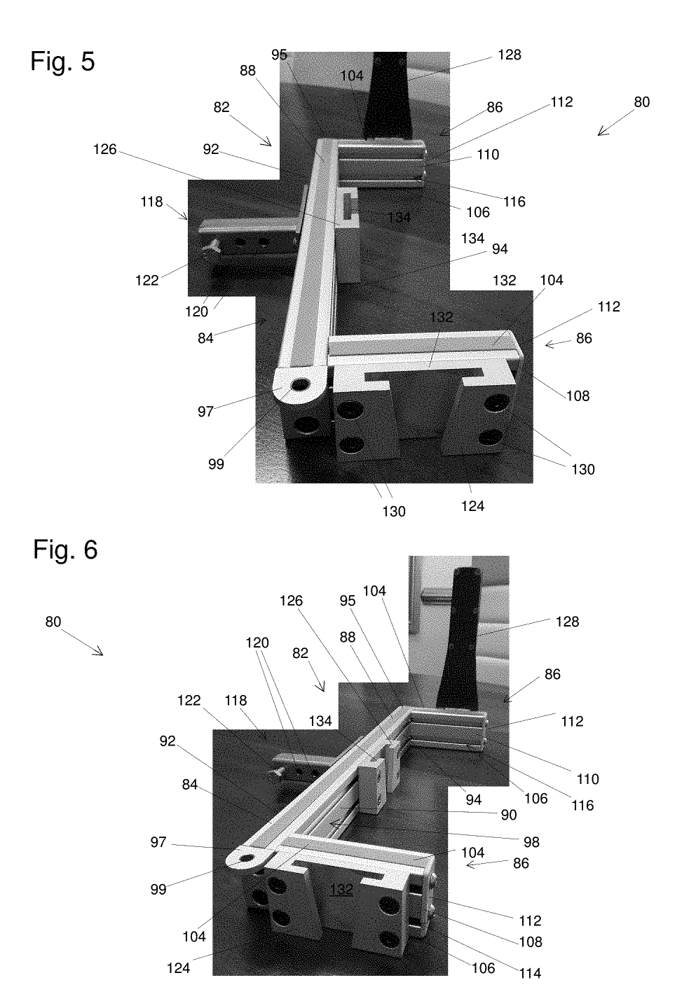

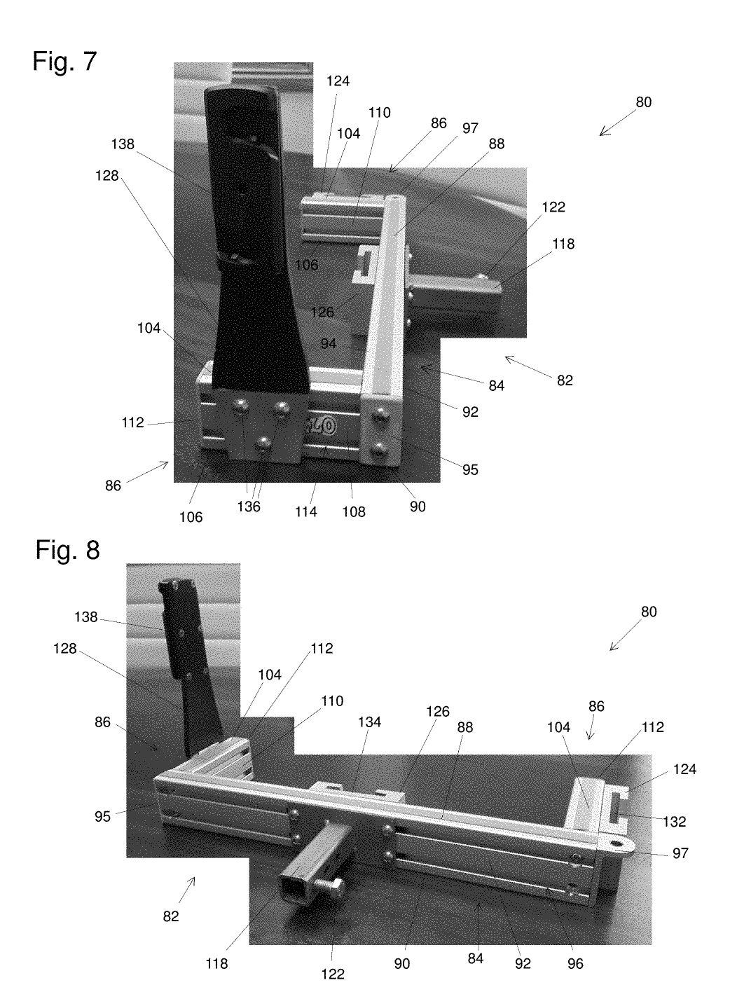

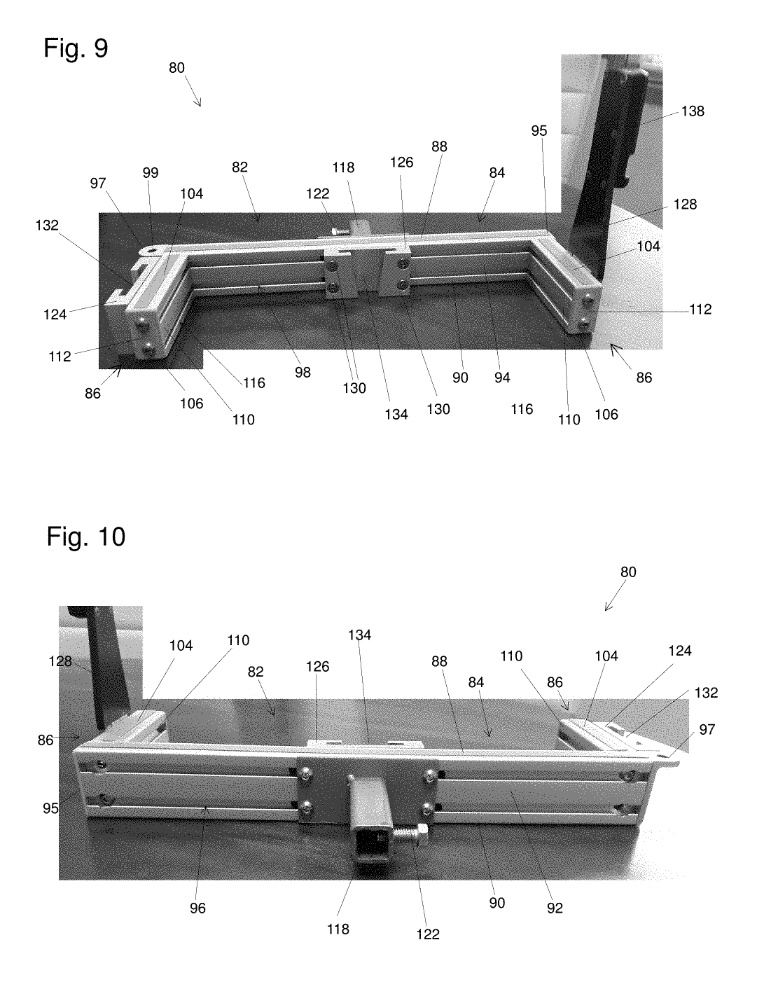

FIGS. 5-10 show a storage system 80 for storing one or more personal articles on a personal mobility device in accordance with the principles of the invention. The storage system 80 includes a frame 82 having an elongate transverse beam 84 and two opposing longitudinal beams 86. The elongate beam 84 is described as transverse because when it is attached to a personal mobility device it extends from one side to the other side of a personal mobility device. Beams 86 are referred to as opposing because they are symmetric mirror images of each other and they extend in a direction parallel to the general direction of motion of the mobility device.

In this embodiment, transverse beam 84 has a top 88, a bottom 90, first side 92, a second side 94, a first end 95 and a second end 97. Both the first side 92 and the second side 94 have linear guide systems 96 and 98, respectively extending along their lengths. Both linear guide systems 96 and 98 have a double track design. Linear guide system 96 has two parallel tracks, both of which are C-shaped channels. Similarly, guide system 98 has two parallel tracks which are also C-shaped channels. Optionally, the linear guide systems 96 and 98 may be single track guides or rail guides. Those skilled in the art will appreciate that there are a wide variety of linear guide system designs.

Each of the longitudinal beams 86 similarly include tops 104, bottoms 106, first sides 108 and second sides 110. Each longitudinal beam 86 extends longitudinally from the transverse beam 84, one at each of the two ends 95 and 97 of the transverse beam 84. Each of the longitudinal beams 86 also include a distal end 112. Each of the first sides 108 have linear guide systems 114. Similarly, each of the second sides 110 have linear guide systems 116. In this embodiment, the linear guide systems 114 and 116 are also double track systems. As with guide systems 96 and 98, guide systems 114 and 116 may optionally be single track, rail, or double rail designs. Those skilled in the art will appreciate that there are a variety of suitable linear guide system designs for use in accordance with the principles of the invention.

In this embodiment, the tops 88 and 104, and the bottoms 90 and 106 are substantially flat and do not include a linear guide system. Optionally, a linear guide system may be incorporated into the tops and/or bottoms of the frame in addition to or in place of the linear guide systems on the sides of the frame. However, the end 97 includes a socket 99 to which a swiveling component may be added to the top 88 of the transverse beam 84.

Frame 82 is C-shaped. However, those skilled in the art will appreciate that a plurality of other frame designs would be suitable. The frame may consist of only a single being that may be transverse or longitudinal to the personal mobility device. Optionally, the frame may consist of several longitudinal and/or transverse beams forming a variety of shapes, such as for example E-shaped, H-shaped, D-shaped or elliptical. Frame 82 has a rectangular cross-section. Optionally, the frame may have a circular, and elliptical and/or a polygonal cross-section. An attachment post 118 is affixed to the linear guide system 96 of the first side 92 and extends perpendicularly from the transverse beam 84. Optionally, the attachment post 118 may be affixed to the frame 82 at a location other than one of the linear guide systems. The attachment post 118 in this embodiment has a rectangular cross-section and is configured to slide inside a female socket positioned behind or underneath a seat of a personal mobility device. The post 118 includes a plurality of bores 120. The bores 120 are sized to permit a bolt 122 to extend through the bores 120 and corresponding aligned bores on a female socket. The bores 120 may be threaded or unthreaded.

FIGS. 5-10 show three carriages 124, 126 and 128. Carriages 124 and 126 are held in position by brakes 130 which in this embodiment are comprised of threaded bolts that may be tightened to secure the carriage at a particular location and may be loosened to allow the carriage to be slid along the linear guide system to a new location where the brakes 130 may be again tightened to secure the carriage in the new location. Carriages 124 and 126 each include a gravity lock 132 and 134, respectively. The gravity locks 132 and 134 allow various components to be removably affixed to the carriages by dropping them into the locks. In this embodiment, the gravity locks 132 and 134 are comprised of chase mortises having an inverse trapezoidal cross-section. This configuration facilitates the easy insertion and removal of various interchangeable components. Carriage 128 includes three brakes 136 comprised of bolts that may be loosened and tightened to adjust the position of the carriage 128. Carriage 128 also includes a magnetic plate 138 that may be used to removably attach a personal article having a complimentary magnetic plate. For example, a cane or an umbrella may be fitted with a magnetic plate that will removably attach to magnetic plate 138.

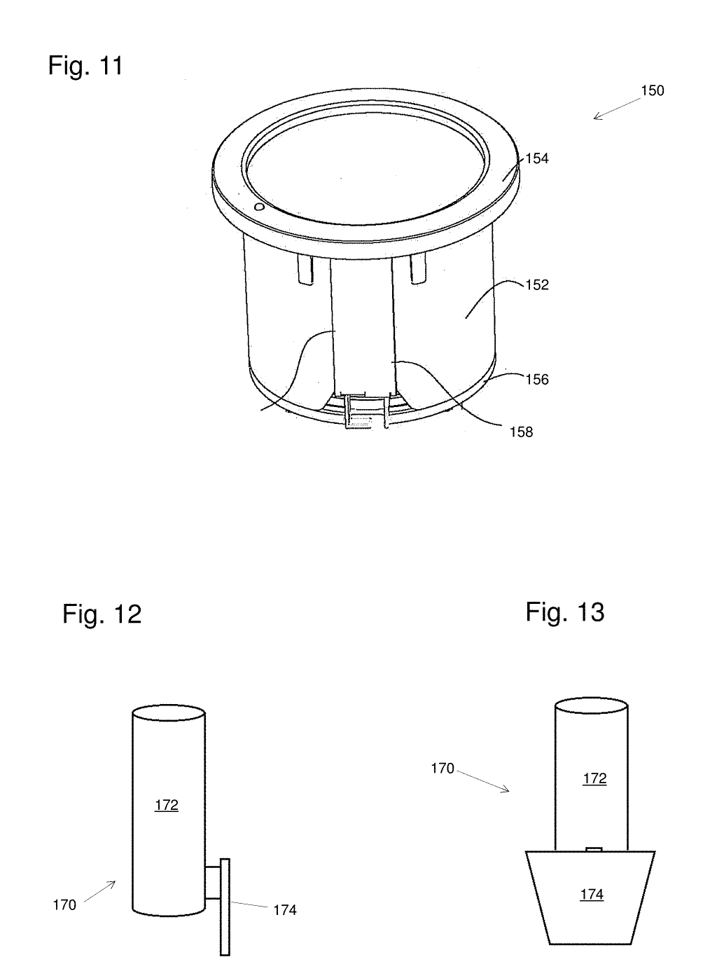

FIG. 11 shows a storage device 150 in accordance with principles of the invention. Storage device 150 is a cup holder having a cylindrical body 152, and annular rim 154, a base 156, and a gravity lock tenon 158. Storage device 150 may be removably affixed to one of the gravity locks 132 or 134 shown in FIGS. 5-10. Optionally, the storage device 150 could be rectangular or polygonal.

FIGS. 12 and 13 show an alternative embodiment of a storage device 170 in accordance with the principles of the invention. Storage device 170 is an umbrella holder having a cylindrical body 172 and a gravity lock tenon 174.

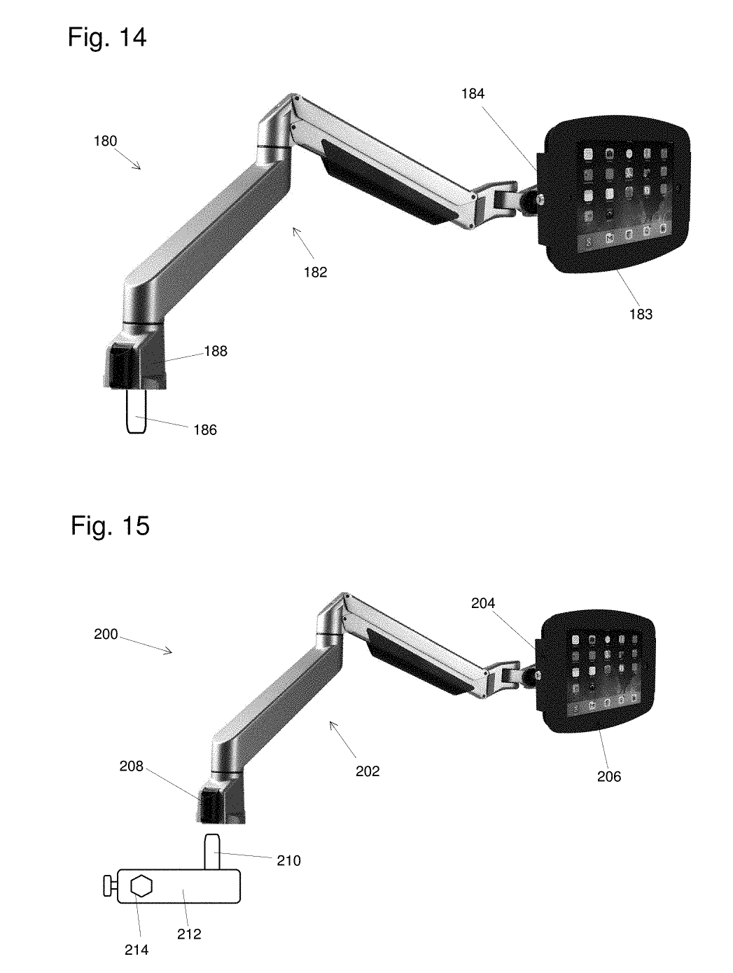

FIG. 14 shows another alternative embodiment of a storage device 180 in accordance with the principles of the invention. The storage device 180 has an articulated arm 182 and a mounting board 184 capable of attaching to a device such as a tablet, a laptop, a notepad or the like. In this embodiment, a tablet 183 is removably affixed to the mounting board 184. A pivot post 186 extends downward from the base 188 and is configured to be removably insertable into the mounting socket 99 shown in FIGS. 5-10 or into another similar pivoting mount.

FIG. 15 shows another alternative embodiment of a storage device 200 in accordance with the principles of the invention. Storage device 200 is an alternative embodiment of an articulating arm. Storage device 200 has an articulating arm 202 and a mounting board 204. In this embodiment, a tablet 206 is removably affixed to the mounting board 204. The base 208 of the storage device 200 includes a socket for receiving a post 210 about which the storage device 200 pivots. Post 210 extends upward from a carriage 212 configured to be slidingly engaged with a linear guide system. The carriage 212 has a brake 214 that allows the carriage 212 to be secured in a desired location.

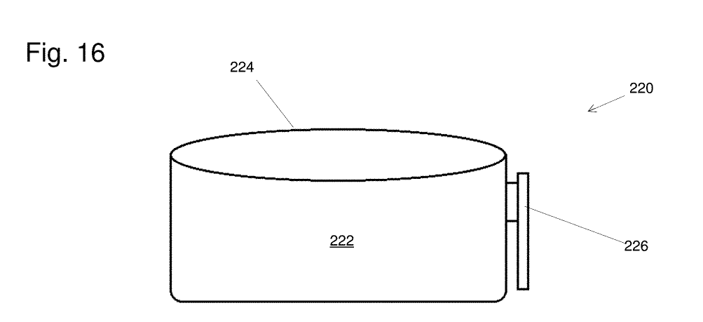

FIG. 16 shows another alternative embodiment of a storage device 220 in accordance with principles of the invention. The storage device 220 is a basket having a body 222 and a rim 224. A gravity lock tenon 226 allows the storage device 220 to be removably attached to a carriage having a chase mortise as shown in FIGS. 5-10.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A storage system for storing one or more personal articles on a personal mobility device comprising:
an elongate frame having a linear guide system extending along a length of the frame;
a mechanism configured to removably attach the frame to a personal mobility device for attaching;
a carriage slidingly engaged to the linear guide system of the elongate frame; and,
wherein the carriage includes at least one storage device selected from the group consisting of a basket, a cup holder, a clamp, a bracket configured to hold a pressurized tank, an umbrella holder, a cane holder, and an articulating arm.

2. The system for storing one or more personal articles on a personal mobility device of claim 1 wherein the storage device is removably attached to the carriage.

3. The system for storing one or more personal articles on a personal mobility device of claim 2, wherein the storage device is removably attached to the carriage by a mechanism selected from the group consisting of a gravity lock, a chase mortise gravity lock, a female receiving port, a mounting post, a threaded mounting post, a bore and a threaded bore.

4. The system for storing one or more personal articles on a personal mobility device of claim 1 wherein the carriage includes a brake configured to secure the carriage at a location along the integral guide system

5. The storage system for storing one or more personal articles of claim 1 further comprising a mounting post extending from the elongate frame and removably secured to the personal mobility device.
